(19) United States
(12) Patent Application Publication
(10) Pub. No.: US 2006/0220614 A1
(43) Pub. Date: Oct. 5, 2006

(54) Electronic endoscope system

(75) Inventor: Kazunori Abe, Saitama (JP)

Correspondence Address: BIRCH STEWART KOLASCH & BIRCH, PO BOX 747, FALLS CHURCH, VA, 22040-0747, US

(73) Assignee: Fujinon Corporation

(21) Appl. No.: 11/392,885

(22) Filed: Mar. 30, 2006

(30) Foreign Application Priority Data
Mar. 31, 2005 (JP) 2005-103232

(51) Int. Cl. H02J 7/00

(52) U.S. Cl. 320/114

(57) ABSTRACT

An electronic endoscope includes: a discharge voltage measuring circuit for measuring discharge voltage of a battery; a time-measuring circuit for measuring period of time for which the battery is used; a remaining available time estimating circuit for obtaining remaining available time tᵣ of the battery based on the result of the measured discharge voltage obtained by the discharge voltage measuring circuit, the result of the measured time obtained by the time-measuring circuit, and a relation between discharge voltage and discharge time of the battery stored in a ROM; and a transmission device for transmitting the remaining available time tᵣ to a processor unit. The processor unit includes: a receiving device for receiving the remaining available time tᵣ from the transmission device; and an image processing unit for displaying a progress bar indicating the remaining available time tᵣ of the battery outside a displaying area of an endoscopic image.

### BACKGROUND OF THE INVENTION

1. Field of the Invention

The present invention relates to an electronic endoscope system including an electronic endoscope loaded with a battery for supplying electric power, a processor unit for generating an endoscopic image, and a monitor for displaying the endoscopic image.

2. Background Arts

In the field of medicine, medical diagnosis using an electronic endoscope is performed extensively conventionally. The electronic endoscope includes an insertion portion. A front end of the insertion portion to be inserted into a body cavity incorporates an image pickup device such as a charge coupled device (CCD). An image pickup signal obtained by the CCD is subjected to signal process by a processor unit, thus making it possible to observe an image within the body cavity (endoscopic image) on a monitor.

As an example of the electronic endoscope, there is an electronic endoscope of so-called battery-driven type, which is loaded with a battery for supplying electric power. The battery is incorporated into a controller manipulated by an operator. There is proposed an electronic endoscope of battery-driven type, in which a remaining amount of the battery is detected and a light emitting diode (LED) provided in the battery or a liquid crystal panel is used for displaying the remaining amount of the battery based on the result of the detection of the remaining amount of the battery. (See Japanese Patent Application Laid-open No. 2001-83434 corresponding to U.S. Pat. No. 6,494,827, and Japanese Patent Application Laid-open No. 2001-155787).

In actual endoscopic diagnosis, the operator observes the endoscopic image displayed on the monitor while manipulating a controller of the electronic endoscope with one hand. Therefore, as in the case of an electronic endoscope disclosed in Japanese Patent Application Laid-open No. 2001-83434 and Japanese Patent Application Laid-open No. 2001-155787, when the battery incorporated into the controller held in one hand of the operator is provided with a function of displaying the remaining amount of the battery, the operator cannot but always pay attention to his/her hand while observing the endoscopic image. Accordingly, there arises a problem in that the operator feels bothered greatly.

### SUMMARY OF THE INVENTION

In view of the foregoing, an object of the present invention is to provide an electronic endoscope system for allowing an operator or viewer to perform endoscopic diagnosis without being bothered.

To achieve the above and other objects, according to an electronic endoscope system of the present invention, an electronic endoscope includes: a battery; a storage device; a discharge voltage measuring device; a time-measuring device; a remaining available time calculating device or estimating device; and a transmission device, and a processor unit includes: a receiving device and a display controlling device. The battery supplies electrical power. The storage device stores a relation between discharge voltage and discharge time of the battery. The discharge voltage measuring device measures the discharge voltage of the battery. The time-measuring device measures a period of time for which the battery is used. The remaining available time calculating device calculates or estimates remaining available time for the battery based on the relation between the discharge voltage and discharge time of the battery stored in the storage device, the result of the measured discharge voltage obtained by the discharge voltage measuring device, and the result of the measured time obtained by the time keeping device. The transmission device transmits the result of the calculated time obtained by the remaining available time calculating device to the processor unit. The receiving device receives the result of the calculated time obtained by the remaining available time calculating device transmitted from the transmission device. The display controlling device displays remaining amount information indicating remaining available time for the battery based on the result of the calculated time obtained by the remaining available time calculating device on the monitor.

When the result of the calculated time obtained by the remaining available time calculating device comes below a predetermined threshold value, the display controlling device displays the remaining amount information on the monitor by making a distinction with a usual case. In this case, the display controlling device changes display color of the remaining amount information or blinks the remaining amount information. The remaining amount information is displayed outside of a displaying area of the endoscopic image on the monitor.

Further, when the result of the calculated time obtained by the remaining available time calculating device comes below a predetermined threshold value, the display controlling device displays a message for prompting replacement of the battery together with the remaining amount information on the monitor.

In a preferred embodiment of the electronic endoscope system according to the present invention, the processor unit further includes a setting changing device for changing a setting of a threshold value.

It is desirable that a progress bar for indicating the remaining available time for the battery by use of the number of bars is used for displaying the remaining amount.

The transmission device/receiving device preferably transmits/receives the result of the calculated time obtained by the remaining available time calculating device through a radio wave. Additionally, the electronic endoscope and the processor unit preferably transmit/receive the image pickup signal through a radio wave.

According to the electronic endoscope system of the present invention, the remaining available time for the battery is calculated in the electronic endoscope and transmitted to the processor unit. Additionally, since the remaining available time for the battery is displayed outside of the displaying area of the endoscopic image of the monitor, the operator can check the remaining amount of the battery while observing the endoscopic image. Therefore, it is possible for the operator to conduct endoscopic diagnosis without being bothered.

### BRIEF DESCRIPTION OF THE DRAWINGS

One with ordinary skill in the art would easily understand the above-described objects and advantages of the present invention when the following detailed description of the preferred embodiments of the present invention is read with reference to the accompanying drawings:

FIG. 1 is a schematic diagram showing constitution of an electronic endoscope system;

FIG. 2 is a block diagram showing constitution of an electronic endoscope;

FIG. 3 is a block diagram showing constitution of a CPU of the electronic endoscope;

FIG. 4 is a graph showing a relation between discharge voltage and discharge time of a battery;

FIG. 5 is a block diagram showing constitution of a processor unit;

FIG. 6 is an explanatory view showing a state where an endoscopic image and a progress bar are displayed on a monitor; and

FIG. 7 is an explanatory view showing a state where a message for prompting replacement of the battery is displayed on the monitor.

### DETAILED DESCRIPTION OF THE EMBODIMENTS

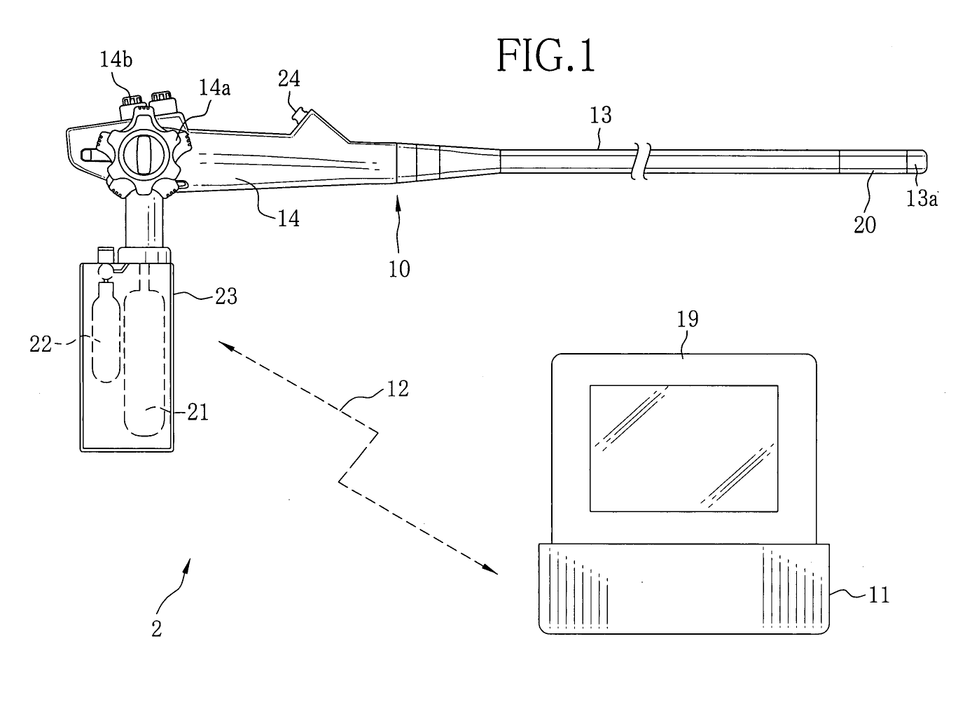

As shown in FIG. 1, an electronic endoscope system 2 is composed of an electronic endoscope 10 and a processor unit 11. In the electronic endoscope system 2, signals are received/transmitted between the electronic endoscope 10 and the processor unit 11 through a radio wave 12. The frequency band of the radio wave 12 is a first frequency band or a second frequency band (for example, 1.2 GHz or 2.4 GHz) to which a plurality of channels are preliminarily allocated.

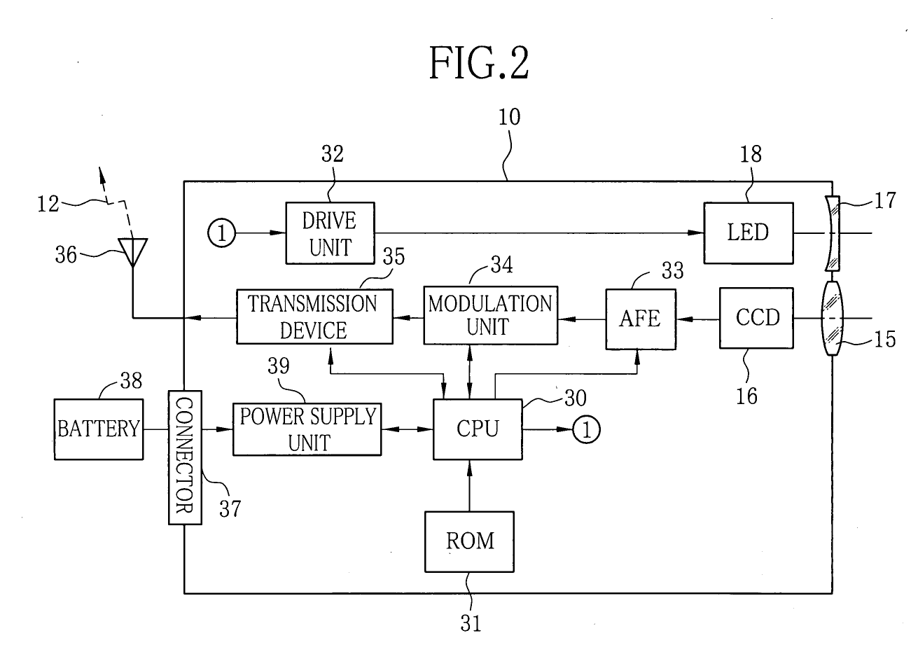

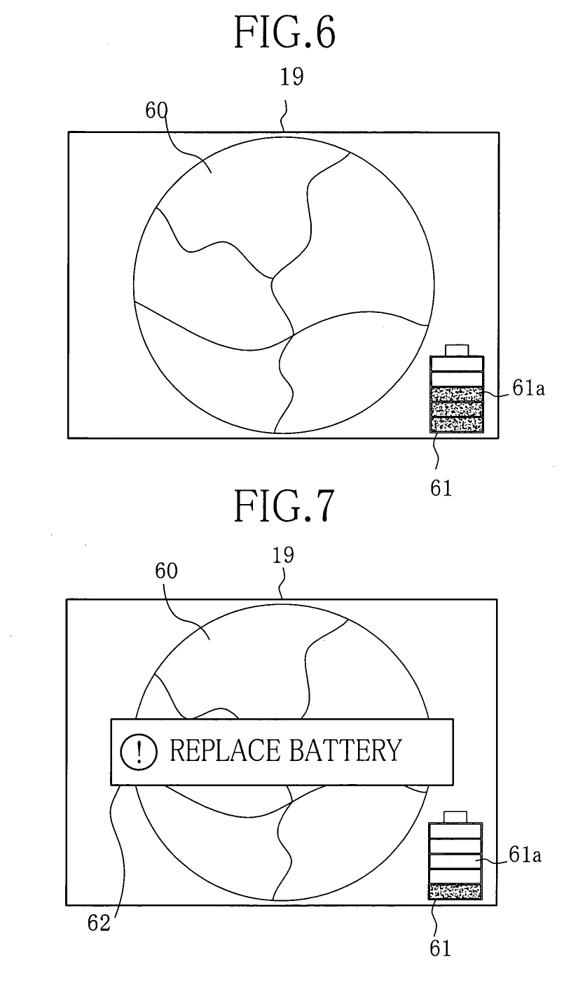

The electronic endoscope 10 includes an insertion tubular portion 13 to be inserted into a body cavity, and a handle 14 arranged so as to be connected to a proximal end of the insertion portion 13. A leading end portion 13a is arranged so as to be connected to a leading end of the insertion portion 13. The leading end portion 13a incorporates an objective lens 15, a charge coupled device (CCD) 16, an illumination lens 17, and a light emitting diode light source (hereinafter abbreviated as LED) 18 (see FIG. 2). The objective lens 15 takes image light of a region to be inspected within the body cavity. The CCD 16 serves as an image pickup device for photographing the region to be inspected within the body cavity. The LED 18 illuminates an interior of the body cavity. An image of the interior of the body cavity obtained by the CCD 16 is displayed as an endoscopic image 60 (see FIG. 6) on a monitor 19 connected to the processor unit 11.

A curving tubular portion 20 is disposed in a back portion of the leading end portion 13a. The curving portion 20 is obtained by connecting a plurality of joint pieces constituting the curving portion. A handle 14 includes an angle knob 14a. The angle knob 14a is operated to push/draw wires housed inside the insertion portion 13. Correspondingly, the curving portion 20 is caused to move in both vertical and horizontal directions while curving, and thus making it possible to direct the leading end portion 13a in a desired direction in the body cavity.

A cartridge 23 is detachably attached to a bottom portion of the handle 14. The cartridge 23 incorporates a water storage tank 21 for storing water and an air cylinder 22 for storing air. In synchronism with an operation of a water supplying/air supplying button 14b of the handle 14, the water and air respectively stored in the water storage tank 21 and the air cylinder 22 pass through a water supplying pipe and an air supplying pipe housed inside the electronic endoscope 10, and are ejected against the objective lens 15 from a washing nozzle (not shown) formed at the leading end portion 13a. As a result, it is possible to remove waste materials adhered to a surface of the objective lens 15 and supply air to the interior of the body cavity. The cartridge 23 is attached to a position on which the base of hand of the operator or viewer abuts, when the operator uses the electronic endoscope 10. Accordingly, the cartridge 23 also serves to stabilize the operability of the electronic endoscope 10. It is noted that the reference numeral 24 denotes a forceps opening for inserting tools for procedure.

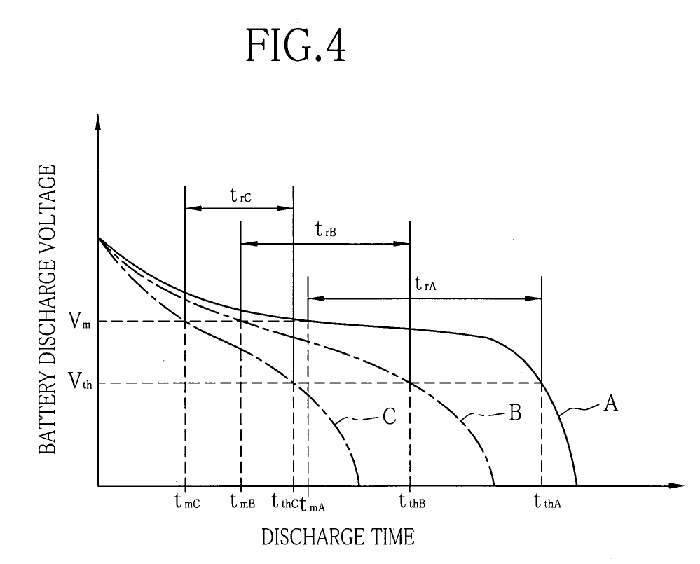

As shown in FIG. 2, the CPU 30 controls the overall operation of the electronic endoscope 10. A read only memory (ROM) 31 is connected to the CPU 30. The ROM 31 stores various programs and data for controlling the operation of the electronic endoscope 10, a relation between discharge voltage and discharge time of a battery 38 (see FIG. 4), and the like. The CPU 30 reads necessary programs and data from the ROM 31 and controls the operation of the electronic endoscope 10.

A drive unit 32 is connected to the LED 18. The drive unit 32 causes the LED 18 to be turned on/off under the control of the CPU 30. The light emitted from the LED 18 is applied to the region to be inspected within the body cavity through the illumination lens 17. It is noted that, there may be adopted a configuration in which the LED 18 is disposed inside the handle 14 instead of being disposed at the leading end portion 13a, and a light guide leads light to the leading end portion 13a.

The CCD 16 focuses the image light of the region to be inspected within the body cavity, which enters through the objective lens 15, onto an imaging surface, and outputs an image pickup signal correspondingly from each pixel. An analog front end (AFE) unit 33 subjects the image pickup signal, which is received from the CCD 16, to correlation double sampling, amplification, and analog/digital (A/D) conversion, thus converting the image pickup signal to a digital image signal.

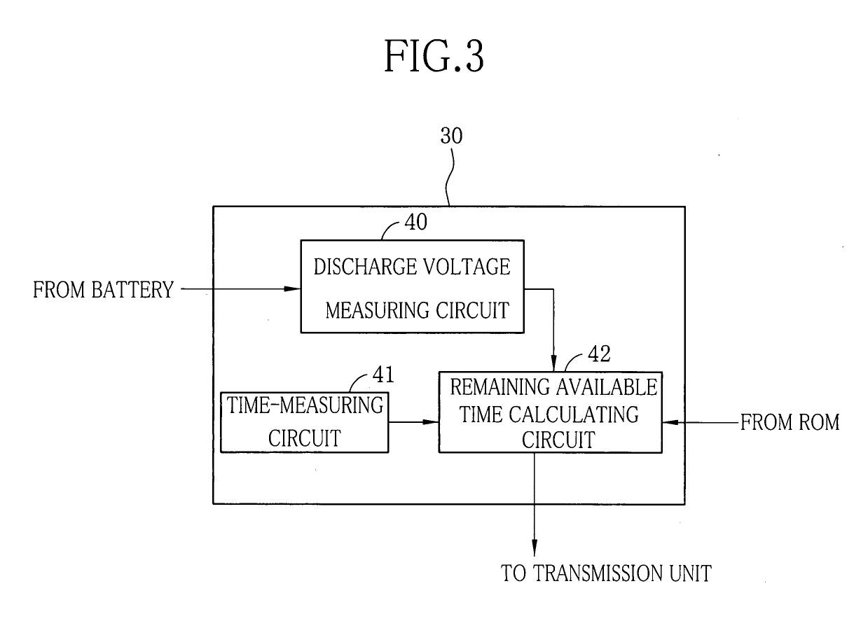

A modulation unit 34 subjects the digital image signal, which is outputted from the AFE 33, to digital orthogonal modulation, for example, thus generating a radio frequency signal (RF signal). A transmission device 35 transmits the RF signal generated by the modulation unit 34, as a radio wave 12 having the first or second frequency band, to the processor unit 11 through an antenna 36. Further, the transmission device 35 transmits a signal representing remaining available time tᵣ for the battery 38, as the radio wave 12, to the processor unit 11. The remaining available time tᵣ for the battery 38 is a result calculated by a remaining available time calculating circuit 42 or estimating circuits (see FIG. 3).

The connector 37 is connected with the battery 38 in which two nickel-hydrogen cell batteries having rated voltage of 1.2 V are connected to each other in serial, for example. The electric power of the battery 38 is supplied to the respective portions of the electronic endoscope 10 from the power supply unit 39 controlled by the CPU 30. It is noted that, although not shown in FIG. 1, in the back portion of the handle 14, there is provided a battery storage chamber for containing the battery 38. The connector 37 is disposed within the battery storage chamber.

As shown in FIG. 3, the CPU 30 includes a discharge voltage measuring circuit 40, a time-measuring circuit 41 or timer, and a remaining available time calculating circuit 42. The discharge voltage measuring circuit 40 measures the discharge voltage of the battery 38 continuously or at a predetermined interval, and subjects the measured discharge voltage to the A/D conversion, thus digitalizing the measured discharge voltage. The discharge voltage measuring circuit 40 transmits the result of the measured digitalized discharge voltage to the remaining available time calculating circuit 42. It is noted that, there arises a return phenomenon, in which when the LED 18 is turned on again after once being turned off, apparent electromotive force of the battery 38 increases. In consideration of such a phenomenon, the discharge voltage measuring circuit 40 incorporates a delay circuit for temporarily delaying the measurement of the discharge voltage so as not to measure the discharge voltage immediately after the LED 18 is turned on.

The time-measuring circuit 41 is activated at the same time as the power supply of the electronic endoscope 10 is turned on, and measures the period of time for which the battery 38 is used. The time-measuring circuit 41 transmits the result of the measured period of time for which the battery 38 is used to the remaining available time calculating circuit 42. The result of the measured time obtained by the time-measuring circuit 41 is cleared when endoscopic diagnosis is completed and the power supply of the electronic endoscope 10 or the processor unit 11 is turned off, or when the connector 37 detects replacement of the battery 38.

FIG. 4 shows the relation between the discharge voltage and discharge time of the battery 38. The relation has characteristics as follows. Once the battery 38 starts to be used, as the time elapses, the discharge voltage gradually decreases. Further, the discharge voltage falls greatly on reaching a certain time. Additionally, as indicated by A to C shown in FIG. 4, the more the number of times of charging increases, the faster the discharge voltage falls in the order from A to C. The ROM 31 stores, as data tables or arithmetic expressions (hereinafter, referred to as data X), the relation between the discharge voltage and discharge time of the battery 38 in a case where the battery 38 is new and the number of times of charging is zero, as indicated by A.

The discharge voltage and the discharge time are respectively denoted by Vₜₕ and tₜₕ at the time when the battery 38 reaches its application limit. The tₜₕ is the available time period for the battery 38 after being fully charged. As the number of times of charging increases, the tₜₕ is shortened as indicated by t_{thA} to t_{thC}. The Vₜₕ, and tₜₕ are respectively predetermined values, and in practical, values slightly before reaching their application limits are respectively set. Further, the result of the measured discharge voltage obtained by the discharge voltage measuring circuit 40 is denoted by Vₘ, and the discharge time at the time of the measurement is denoted by tₘ (as in the case of tₜₕ, as the number of times of charging increases, the tₘ is shortened as indicated by t_{mA} to t_{mC}). The remaining available time for the battery 38, which is denoted by tᵣ (hereinafter, referred to as remaining available time tᵣ), is obtained by subtracting tₘ from tₜₕ.

As described above, as the number of times of charging increases, the tₜₕ is shortened. Accordingly, when the remaining available time tᵣ is calculated by using the t_{thA}, that is, a new battery without charging, the result of calculation becomes t_{rA}, which should be normally t_{rB} or t_{rC} in a case where the battery 38 is not new. Thus, error occurs. The tₜₕ can be estimated accurately to some extent based on the result of the measured time obtained by the time-measuring circuit 41 at the time when the result of the measured discharge voltage obtained by the discharge voltage measuring circuit 40 reaches a predetermined value, and according to the relation between the discharge voltage and discharge time indicated by A shown in FIG. 4. Therefore, the ROM 31 stores data tables or arithmetic expressions (hereinafter, referred to as data Y) for obtaining the tₜₕ based on the result of the measured time obtained by the time-measuring circuit 41 at the time when the result of the measured discharge voltage obtained by the discharge voltage measuring circuit 40 reaches a predetermined value (2V, for example), and according to the relation between the discharge voltage and discharge time indicated by A shown in FIG. 4. The remaining available time calculating circuit 42 obtains the tₜₕ by use of the data Y so as not to generate the above error. Note that, the data X and Y are preliminarily obtained by experiments.

The remaining available time calculating circuit 42 or estimating circuit reads the data X and Y from the ROM 31. The remaining available time calculating circuit 42 estimates the available time period tₜₕ by referring to the data Y, and according to measured time tₜᵢₘₑᵣ of the time-measuring circuit 41 and a relationship determined between the measured discharge voltage Vₘ and the available time period t_{thA} according to the data X, the measured time tₜᵢₘₑᵣ being measured upon reach of the measured discharge voltage Vₘ of the discharge voltage measuring circuit 40 to a predetermined level. Then, the result tₜₕ is subtracted by the result of the measured time tₜᵢₘₑᵣ obtained by the time-measuring circuit 41, thus obtaining the remaining available time tᵣ. The remaining available time calculating circuit 42 transmits the calculated remaining available time tᵣ to the transmission device 35 through the intermediation of the modulation unit 34.

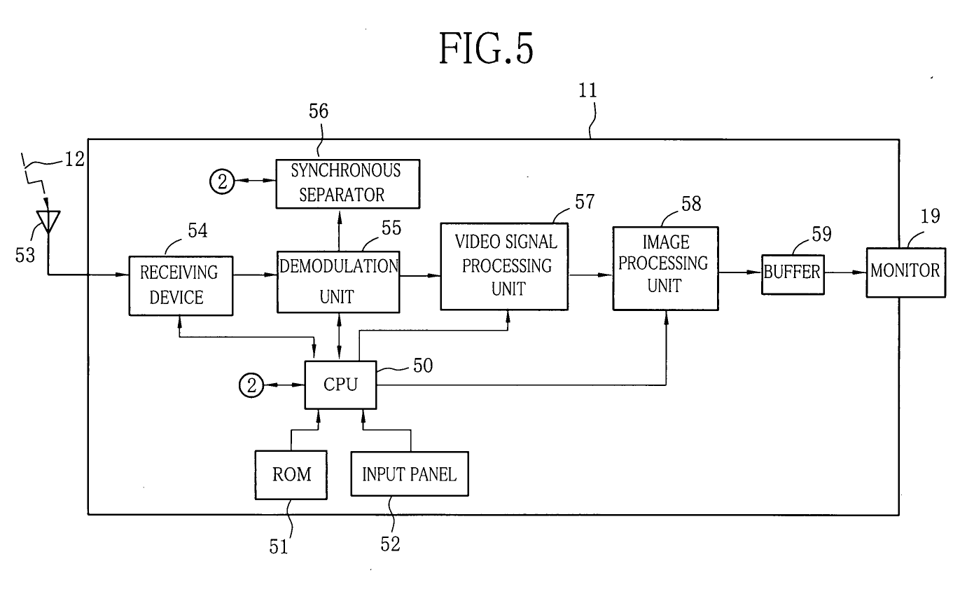

The modulation unit 34 modulates the remaining available time tᵣ output from the remaining available time calculating circuit 42, to a radio signal. The transmission device 35 transmits the radio signal representing the remaining available time tᵣ to a receiving device 54 (see FIG. 5) of the processor unit 11 as the radio wave 12 through the antenna 36. The transmission device 35 transmits the radio signal representing the remaining available time tᵣ by use of a synchronous period of the RF signal so as not to overlap with a period when the RF signal is transmitted as the radio wave 12. It is noted that, the radio signal representing the remaining available time tᵣ may be transmitted by the transmission device 35 by use of a dedicated channel (0 channel) apart from the channel used for transmitting the RF signal as the radio wave 12.

As shown in FIG. 5, a CPU 50 controls the overall operation of the processor unit 11. The CPU 50 is connected to a ROM 51 and an input panel or keypad 52. The ROM 51 stores various programs and data for controlling the operation of the processor unit 11. The input panel 52 includes a keyboard and a mouse. The CPU 50 reads necessary programs and data from the ROM 51, and controls the operation of the processor unit 11. Further, the CPU 50 activates the respective portions of the processor unit 11 in accordance with an operation input signal from the input panel 52.

An antenna 53 receives the radio wave 12 from the electronic endoscope 10. The receiving device 54 amplifies the radio wave 12 received through the antenna 53, that is, the RF signal. A demodulation unit 55 subjects the RF signal to the digital orthogonal detector, for example, and demodulates the RF signal to the image signal, the image signal being one before being modulated in the electronic endoscope 10. Further, the receiving device 54 and the demodulation unit 55 receive the radio signal presenting the remaining available time tᵣ, which is transmitted from the transmission device 35, by use of the synchronous period of the RF signal or 0 channel, and demodulates the remaining available time tᵣ.

A synchronous separator 56 separates a synchronizing signal from the image signal demodulated by the demodulation unit 55 through amplitude separation under the control of the CPU 50. Subsequently, the synchronous separator 56 separates a horizontal synchronizing signal and a vertical synchronizing signal therefrom through frequency separation. A video signal processing unit 57 generates a digital video signal by use of the image signal. An image processing unit 58 subjects the video signal generated by the video signal processing unit 57 to mask generation and various image processes such as addition of character information including a progress bar 61 (see FIG. 6). The buffer 59 is subjected to various image processes by the image processing unit 58, and temporarily stores the video signal displayed as the endoscopic image 60 on the monitor 19.

The radio signal presenting the remaining available time tᵣ demodulated by the demodulation unit 55 is transmitted to the image processing unit 58 through the intermediation of the CPU 50. As shown in FIG. 6, the image processing unit 58 as display controlling device displays the progress bar 61 outside of the displaying area of the endoscopic image 60. The progress bar 61 indicates remaining amount of the battery 38 based on the remaining available time tᵣ. The progress bar 61 shows the remaining available time tᵣ by use of the number of bars 61a (shaded portion in the drawing). The number of bars 61a is increased/decreased in proportion to the ratio of the remaining available time tᵣ to the available time period tₜₕ. That is, taking a state shown in the drawing as an example for explanation, the number of the bars 61a is 3 out of 5, which means that the ratio of the remaining available time tᵣ to the available time period tₜₕ is as follows: 3/5 multiplied by 100 equals 60%.

Further, as shown in FIG. 7, when the remaining available time tᵣ comes below a predetermined threshold value (for example, when the ratio of the remaining available time tᵣ to the available time period tₜₕ comes below 10%), the image processing unit 58 displays a message 62 for prompting the replacement of the battery 38 together with the progress bar 61. Simultaneously, the image processing unit 58 changes the display color of the progress bar 61 from green as a normal color to red or blinks the progress bar 61 itself, thus displaying the progress bar 61 by making a distinction with a usual case. The setting of the threshold value can be changed by controlling the controller 52 as a setting changing device.

When the interior of the body cavity is observed by use of the electronic endoscope system 2 configured as described above, the insertion portion 13 is inserted into the body cavity, and the LED light source 18 is turned on to illuminate the interior of the body cavity, thus observing the endoscopic image 60 obtained by the CCD 16 on the monitor 19.

At this time, image light of the region to be inspected within the body cavity entering through the objective lens 15 is focused on the imaging surface of the CCD 16, and thereby the image pickup signal is outputted from the CCD 16. The image pickup signal outputted from the CCD 16 is subjected to the correlation double sampling, amplification, and A/D conversion, by the AFE 33, thus converting the image pickup signal to the digital image signal.

The digital image signal, which is outputted form the AFE 33, is subjected to digital orthogonal modulation by the modulation unit 34, to be the RF signal. The RF signal is amplified in the transmission device 35, and transmitted through the antenna 36 as the radio wave 12.

In the processor unit 11, when the antenna 53 receives the radio wave 12 transmitted through the antenna 36 of the electronic endoscope 10, the radio wave 12, that is, the RF signal is amplified in the receiving device 54. In the modulation unit 55, the RF signal amplified in the receiving device 54 is subjected to the digital orthogonal detector, and the RF signal is demodulated to the image signal, the image signal being one before being demodulated in the electronic endoscope 10.

The image signal demodulated by the demodulation unit 55 is subjected to the synchronous separation by the synchronous separator 56 under the control of the CPU 50, and outputted from the video signal processing unit 57 as the digital video signal. The video signal outputted from the video signal processing unit 57 is subjected to the various image processes by the image processing unit 58, temporarily stored in the buffer 59, and displayed on the monitor 19 as the endoscopic image 60. As described above, between the electronic endoscope 10 and the processor unit 11, the data of the endoscopic image 60 are transmitted/received through the radio wave 12.

When endoscopic diagnosis is started, in the electronic endoscope 10, the discharge voltage measuring circuit 40 measures the discharge voltage of the battery 38. Additionally, the time-measuring circuit 41 starts to measure the period of time for which the battery 38 is used. In the discharge voltage measuring circuit 40, the measured discharge voltage of the battery 38 is subjected to A/D conversion, and the discharge voltage is digitalized. The discharge voltage of the battery 38 digitalized by the discharge voltage measuring circuit 40, and the result of the measured time obtained by the time-measuring circuit 41 are transmitted to the remaining available time calculating circuit 42.

The remaining available time calculating circuit 42 reads the data X and Y from the ROM 31. Then the available time period tₜₕ is estimated by referring to the data Y, and according to the measured discharge voltage Vₘ of the discharge voltage measuring circuit 40, and measured time tₜᵢₘₑᵣ of the time-measuring circuit 41 upon obtaining the measured discharge voltage Vₘ, and a relationship determined between the measured discharge voltage Vₘ and the available time period t_{thA} according to the data X. Thereafter, the calculated available time period tₜₕ is subtracted by the result of the measured time tₜᵢₘₑᵣ obtained by the time-measuring circuit 41, thus obtaining the remaining available time tᵣ. The remaining available time tᵣ obtained by the remaining available time calculating circuit 42 is transmitted to the transmission device 35 through the intermediation of the modulation unit 34, and further transmitted to the receiving device 54 of the processor unit 11 as the radio wave 12 by use of the synchronous period of the RF signal or 0 channel.

In the processor unit 11, the radio signal representing the remaining available time tᵣ is received by the receiving device 54 and demodulated by the demodulation unit 55. The demodulated radio signal representing the remaining available time tᵣ is transmitted to the image processing unit 58 through the intermediation of the CPU 50. The progress bar 61 indicating the remaining amount of the battery 38 based on the remaining available time tᵣ is displayed outside the displaying area of the endoscopic image 60 on the monitor 19 under the control of the image processing unit 58. When the remaining available time tᵣ comes below the predetermined threshold value, the message for prompting the replacement of the battery 38 is displayed together with the progress bar 61. Further, by changing the display color of the progress bar 61, blinking the progress bar 61 itself, or the like, the progress bar 61 is displayed to make a distinction with a usual case.

As described above, according to the electronic endoscope system 2 to which the present invention is applied, the remaining available time tᵣ for the battery 38 is calculated in the electronic endoscope 10 and transmitted to the processor unit 11, thus displaying the progress bar 61 indicating the remaining available time for the battery 38 outside the displaying area of the endoscopic image 60 on the monitor 19. Accordingly, the operator or viewer can check the remaining amount of the battery 38 while observing the endoscopic image 60. Therefore, it is possible for the operator to conduct endoscopic diagnosis without further difficulty.

Further, when the remaining available time tᵣ comes below the predetermined threshold value, the message 62 for prompting the replacement of the battery 38 is displayed together with the progress bar 61, and thus the progress bar 61 is displayed to make a distinction with a usual case. Accordingly, the operator can immediately take appropriate action including replacing the battery 38.

It is noted that, when the capacity of the ROM 31 is much larger than required, the relation between the discharge voltage and discharge time of the battery 38 which is to be stored on the ROM 31 may be not only the relation indicated by A shown in FIG. 4 but also the relation indicated by B or C, that is, a plurality of relations based on the number of times of charging of the battery 38 and the type of the battery 38. Thereby, according to the battery to be used, one that is to be used for the calculation of the remaining available time tᵣ may be changed. By employing such a configuration, it is possible to acquire more accurate remaining available time tᵣ in comparison with the above embodiment in which the operator cannot but depend on a prediction to some extent for the calculation of the remaining available time tₜₕ.

In the above embodiment, although the electronic endoscope system 2, in which signals are received/transmitted through the radio wave 12, is taken as an example for explanation, the present invention is not limited thereto. The present invention is also applicable to an electronic endoscope system to which an electronic endoscope and a processor unit are connected through a signal cable.

The remaining amount information described above is displayed outside of a displaying area of the endoscopic image on the monitor. However, the remaining amount information may be displayed within the displaying area of the endoscopic image on the monitor.

In the above embodiment, although the electronic endoscope system 2 for medical use is taken as an example for explanation, the present invention is not limited thereto. The present invention is also applicable for industrial application such as photographing an interior of a narrow tube.

Thus the present invention is not to be limited to the above embodiments but, on the contrary, various modifications will be possible without departing from the scope and spirit of the present invention as specified in claims appended hereto.

What is claimed is:

1. An electronic endoscope system including an electronic endoscope provided with an image pickup device for photographing a region to be inspected within a body cavity, a processor unit for generating an endoscopic image using said image pickup signal outputted from said image pickup device, and an endoscope monitor for displaying said endoscopic image, said electronic endoscope system comprising:
A. said electronic endoscope including:
a battery for supplying electrical power;
a storage device for storing a relation between discharge voltage and discharge time of said battery;
a discharge voltage measuring device for measuring the discharge voltage of said battery;
a time-measuring device for measuring a period of time for which said battery is used;
a remaining available time estimating device for estimating remaining available time for said battery, said remaining available time estimating device performing the estimation based on the relation between the discharge voltage and discharge time of said battery that is stored in said storage device, the result of the measured discharge voltage obtained by said discharge voltage measuring device, and the result of the measured time obtained by said time-measuring device; and
a transmission device for transmitting the result of the estimated time obtained by said remaining available time estimating device to said processor unit,
B. said processor unit including:
a receiving device for receiving the result of the estimated time obtained by said remaining available time estimating device transmitted from said transmission device; and
a display controlling device for controlling display of said monitor, said display controlling device being configured to display remaining amount information indicating remaining available time for said battery based on the result of the estimated time obtained by said remaining available time estimating device on said monitor.

2. An electronic endoscope system as defined in claim 1, wherein, said remaining amount information is displayed outside of a displaying area of said endoscopic image.

3. An electronic endoscope system as defined in claim 1, wherein, when the result of the estimated time obtained by said remaining available time estimating device comes below a predetermined threshold value, said display controlling device displays said remaining amount information said monitor by making a distinction with a usual case.

4. An electronic endoscope system as defined in claim 3, wherein, when the result of the estimated time obtained by said remaining available time estimating device comes below a predetermined threshold value, said display controlling device changes a display color of said remaining amount information or blinks said remaining amount information.

5. An electronic endoscope system as defined in claim 1, wherein, when the result of the estimated time obtained by said remaining available time estimating device comes below a predetermined threshold value, said display controlling device displays a message for prompting replacement of said battery together with said remaining amount information on said monitor.

6. An electronic endoscope system as defined in claim 5, further comprising a setting changing device for changing a setting of a threshold value, said setting changing device being provided in said processor unit.

7. An electronic endoscope system as defined in claims 1, wherein said display controlling device uses a progress bar indicia for indicating the remaining available time for said battery by use of the number of bar indicia, said progress bar indicia serving as said remaining amount information.

8. An electronic endoscope system as defined in claims 1, wherein a radio wave is used in said transmission device and said receiving device to transmit or receive the result of the estimated time obtained by said remaining available time estimating device.

9. An electronic endoscope system as defined in claims 1, wherein said electronic endoscope and said processor unit transmit and receive said image pickup signal through a radio wave.
